(19) United States
(12) Patent Application Publication
(10) Pub. No.: US 2023/0244436 A1
(43) Pub. Date: Aug. 3, 2023

(54) METHOD AND SYSTEM FOR SWITCHING MULTI-FUNCTION MODES

(71) Applicant: Chiun Mai Communication Systems, Inc., New Taipei (TW)

(72) Inventors: WEN-YI KUO, Taipei (TW); CHUNG-TSUNG WANG, New Taipei (TW); JU-CHI HSUEH, Taipei (TW); CHENG-FENG YEH, New Taipei (TW); WEI-CHENG WANG, New Taipei (TW)

(21) Appl. No.: 17/891,528

(22) Filed: Aug. 19, 2022

Related U.S. Application Data
(60) Provisional application No. 63/304,095, filed on Jan. 28, 2022.

(51) Int. Cl. G06F 3/16

(52) U.S. Cl. CPC G06F 3/162

(57) ABSTRACT

A method and a system for switching multi-function modes applied in an electronic device having a plurality of hardware module functions, and includes receiving input information from a user of the electronic device; obtaining status information of the electronic device; and switching the electronic device to one of the multi-function modes according to the input information and the status information, each of the multi-function modes corresponds to at least one of the plurality of hardware module functions.

### CROSS-REFERENCE TO RELATED APPLICATIONS

This application claims priority to U.S. Patent provisional Application No. 63/304,095 filed on Jan. 28, 2022, the contents of which are incorporated by reference herein.

### FIELD

The subject matter herein generally relates to electronic device technology, and particularly to a method and a system for switching multi-function modes.

### BACKGROUND

Electronic devices, such as smart speakers, may be arranged with multiple functions. However, the functions of the electronic device may be supported by hardware, normally the different functions needs to be manually instructed by users, which is low in intelligentialization level.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a schematic view of at least one embodiment of an electronic device having a system for switching multi-function modes.

FIG. 2 illustrates another schematic view of at least one embodiment of the electronic device having the system for switching multi-function modes.

FIG. 3 is a flowchart of at least one embodiment of a method for switching multi-function modes.

FIG. 4 is another flowchart of at least one embodiment of a method for switching multi-function modes.

FIG. 5 is a flowchart of one embodiment of the method for switching multi-function modes to a meeting mode.

FIG. 6 is a flowchart of one embodiment of the method for switching multi-function modes to a smart light mode.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as Java, C, or assembly. One or more software instructions in the modules can be embedded in firmware, such as in an EPROM. The modules described herein can be implemented as either software and/or hardware modules and can be stored in any type of non-transitory computer-readable medium or storage device. Some non-limiting examples of non-transitory computer-readable media include CDs, DVDs, BLU-RAY, flash memory, and hard disk drives. The term “comprising” means “including, but not necessarily limited to”; it in detail indicates open-ended inclusion or membership in a so-described combination, group, series, and the like.

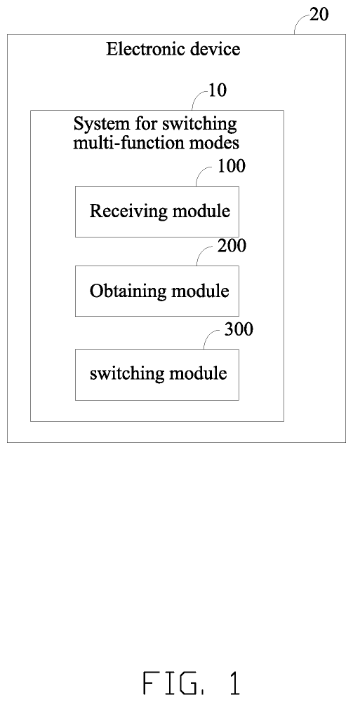

FIG. 1 illustrates a system 10 for switching multi-function modes. The system 10 may be applied in an electronic device 20. The electronic device 20 may include a number of hardware modules for performing a number of functions. Different functions of the electronic device 20 may be performed by one or more hardware modules. The system 10 may invoke other hardware modules of the electronic device 20 for receiving information and performing corresponding functions.

The system 10 includes a receiving module 100, an obtaining module 200, and a switching module 300. In at least one embodiment, the receiving module 100 is configured to receive input information. The obtaining module 200 is configured to obtain status information of the electronic device 20. The switching module 300 is configured to switch to one mode of the electronic device 20 according to the input information and the status information. The multi-function modes correspond to a number of functions of the hardware modules.

In at least one embodiment, one of the multi-function modes of the electronic device 20 may be a meeting mode. For example, the receiving module 100 receives the input information, the obtaining module 200 analyzes the input information and identifies the identity of the user and the corresponding mode, such as the meeting mode. Then, the switching module 300 invokes corresponding hardware modules of the electronic device 20 to switch the electronic device 20 to the meeting mode and automatically joining the meeting according to the identity of the user.

The input information may include voice command from the user, Near Field Communication (NFC) input information from the user or a device of the user, audio input information of the user, text input information of the user, fingerprint of the user, the facial input of the user, iris input of the user, and clicking and selecting operations on a software system by the user.

The obtaining module 200 may obtain the status information of the electronic device 20 according to positioning information or Wi-Fi identification information of the electronic device 20, and switch the electronic device 20 to one of the multi-function modes.

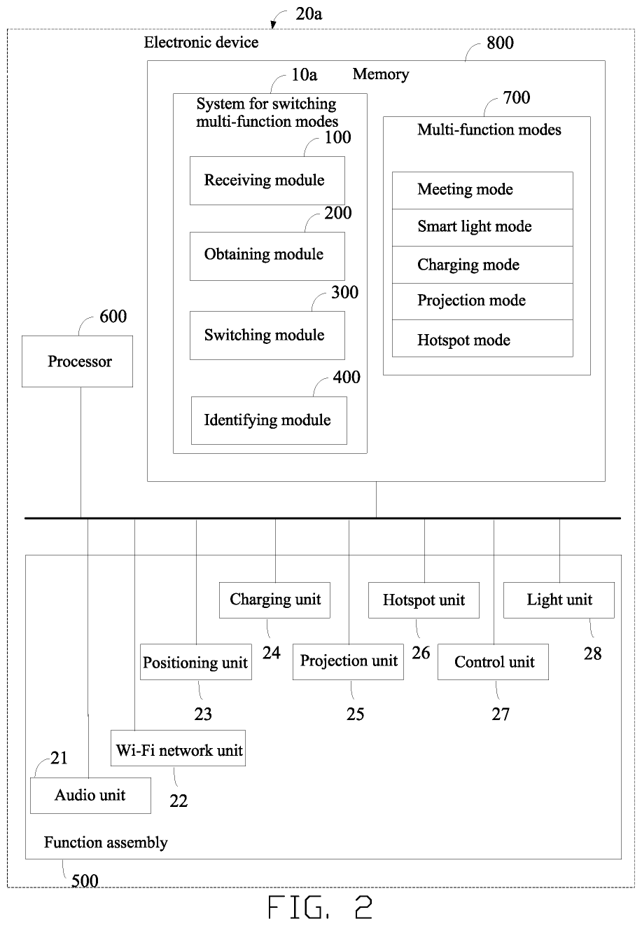

Referring to FIG. 2, a system 10a for switching multi-function modes further includes an identifying module 400. The identifying module 400 is configured to identify the identity information of the user according to the input information of the user. In detail, the identifying module 400 switches the electronic device 20a to one of multi-function modes according to one of the input information of the user, the identity information of the user, and the status information of the electronic device 20a. The electronic device 20a further includes a function assembly 500, a processor 600, and a memory 800. The function assembly 500 at least includes an audio unit 21 and a control unit 27. In at least one embodiment, the system 10a may receive the input information from the user through the hardware modules of the electronic device 20a. For instance, the receiving module 100 may receive the audio input information of the user through the audio unit 21, and transmit the audio input information to the identifying module 400.

In at least one embodiment, the switching module 300 receives the identity information according to the input information identified by the identifying module 400 and a target function identified by the identifying module 400, switch the electronic device 20a to a corresponding multi-function mode 700. Furthermore, the switching module 300 is further configured to transmit the identity information of the user and the target function to the control unit 27. The control unit 27 is configured to execute corresponding functions when the electronic device 20a is switched to a corresponding multi-function mode 700.

For instance, the function assembly 500 further includes a light unit 28. The light unit 28 includes LEDs for executing a smart light mode. When the smart light mode is executed, the light unit 28 may light up and strobe one or more LEDs. Thus, when the multi-function modes of the electronic device 20a include the smart light mode, and when the switching module 300 switches the electronic device 20a to the smart light mode, the control unit 27 controls the light unit 28 to light up or strobe one or more LEDs according to the smart light mode.

In at least one embodiment, the audio unit 21 may further include audio output function, the electronic device 20a may control the audio unit 21 to play music. In at least one embodiment, when the audio unit 21 plays music, the electronic device 20a may obtain light adjusting information from the music played. The electronic device 20a synchronously switches to the smart light mode and adjusts the LEDs according to the light adjust information. For instance, adjusting a frequency of strobing of the LEDs, the color of the LEDs, or the brightness of the LEDs to match the music rhythm.

In at least one embodiment, the control unit 27 is configured to obtain a time of the electronic device 20a, determine whether the time is during a night time, and automatically switch on the smart light mode when the time of the electronic device 20a is determined to be in the night time. In at least one embodiment, the status information of the electronic device 20a may include the time information of the electronic device 20a.

In at least one embodiment, the electronic device 20a is configured to obtain echo information of the audio in the meeting mode through the audio unit 21. The electronic device 20a may adjust audio setting of the meeting mode according to the echo information, so as to improve an audio communication quality in the meeting mode.

In at least one embodiment, the processor 600 can be formed by integrated circuits, such as an individual integrated circuit or multiple integrated circuits with a same function or different functions. The processor 600 includes, but is not limited to, a central processing unit (CPU), a microprocessor, a digital signal processor (DSP), a graphics processor, an application specific integrated circuit (ASIC), a field-programmable gate array (FPGA), a data processor chip, a programmable logic device (PLD), a discrete gate/transistor logic device, or a discrete hardware component. The processor 600 may be a control unit and electrically connected to other elements of the electronic device 20a through interfaces or communication bus. In at least one embodiment, the various types of non-transitory computer-readable storage mediums stored in the memory 800 can be processed by the processor 600 to perform various of functions, such as the method for multi-function mode switching.

In at least one embodiment, the memory 800 can include various types of non-transitory computer-readable storage mediums. For example, the memory 800 can store local paths and computer instructions of the method for multi-function mode switching. The memory 800 can rapidly and automatically access instructions and data when the electronic device 20a is running. The memory 800 can be an internal storage system, such as a flash memory, a Random Access Memory (RAM) for the temporary storage of information, and/or a Read-Only Memory (ROM), a Programmable Read-Only Memory (PROM), Erasable Programmable Read-Only Memory (EPROM), a One-time Programmable Read-Only Memory (OTPROM), Electrically-Erasable Programmable Read-Only Memory (EEPROM), Compact Disc Read-Only Memory (CD-ROM) for permanent storage of information. The memory 800 can also be an external storage system, such as a hard disk, a storage card, or a data storage medium. The memory 800 may store software modules, such as the system 10a for switching multi-function modes and the multi-function modes 700.

In at least one embodiment, the multi-function modes 700 may include meeting mode, smart light mode, charging mode, projection mode, and hotspot mode.

The electronic device 20a may further include a charging unit 24, a projection unit 25, and a hotspot unit 26. Correspondingly, the electronic device 20a further includes a charging mode, a projection mode, and a hotspot mode.

In at least one embodiment, the electronic device 20a may detect whether there is an external device connected to the electronic device 20a through a sensor, and switch on the hotspot mode when there is an external device connected to the electronic device 20a.

In at least one embodiment, the electronic device 20a may charge other devices through the charging unit 24. For instance, the charging unit 24 may include a USB interface, a TYPE-C interface, a Lightning interface, etc. The charging unit 24 may further include a wireless charging coil for wirelessly charging other devices.

When the electronic device 20a is switched to the charging mode, the control unit 27 may switch on the charging unit 24 to control the electronic device 20a to charge other devices.

In at least one embodiment, the identifying module 400 may further detect whether a power receiving device is approaching and switch on a wireless charging mode when a power receiving device is positioned within a predetermined distance, for wirelessly receiving power from the electronic device 20a.

In at least one embodiment, the electronic device 20a may apply the projection mode through the projection unit 25. For instance, when the electronic device 20a is switched to the meeting mode, the projection unit 25 may project the shared data in the meeting. In at least one embodiment, the projection unit 25 may project the shared data including a shared document, a shared window, a shared picture, and/or a shared interface, but not limited thereto, shared by remote meeting participants.

The identifying module 400 may identify the identity information of the user according to the audio input information of the user. In detail, the identifying module 400 may identify keywords in the audio input information. For instance, when the identifying module 400 detects keywords like “meeting”, “light”, “charging”, “projection”, or “hotspot”, according to a mode of keywords matching and a mode of keywords corresponding, such as the keyword “meeting” is matched to the meeting mode, the keyword “light” is matched to the smart light mode, etc.

In at least one embodiment, the identifying module 400 may identify the identity information of the user by other ways. For instance, the identifying module 400 may identify the identity information of the user by the logged in information. Login information for logging into a cloud software, an instant messaging software, a calendar software in the electronic device 20a, may be used to determine the identity information of the user. The identifying module 400 may determine the identity information of the user by the login information, such as a software account. For example, the user logs in the electronic device 20a with a Google account, the identifying module 400 may determine the identity information of the user according to the Google account and transmit the identity information to the switching module 300.

In at least one embodiment, the input information from the user may comprise light information. When the identifying module 400 determines the identity information of the user by software account, the identifying module 400 may switch on the smart light mode corresponding to the identity information of the user. For example, when the input information of the user includes light information, the identifying module 400 search for a configuration profile corresponding to the identity information of the user, the identifying module 400 obtains light controlling information according to the configuration profile and switches the electronic device 20a to the smart light mode.

In at least one embodiment, the identifying module 400 may further include a voiceprint identifying module for identifying the identity information of the user according to the audio input information, the identifying module 400 transmits the identity information of the user to the switching module 300. In at least one embodiment, the identifying module 400 may further include other biometric sensors for identifying the identity information of the user.

In at least one embodiment, when the identifying module 400 receives the keyword “meeting” and determine the identity information of the user, control unit 27 invokes calendars of identified user stored in the electronic device 20a or stored in the server which may be accessed by the electronic device 20a, obtains calendars including meeting information.

In at least one embodiment, the input information of the electronic device 20a may comprise the meeting information. User may directly command the electronic device 20a to switch to the meet mode or directly input meeting link to the electronic device 20a to establish a meeting. In at least one embodiment, and the identifying module 400 may further identify calendar information according to the identity of the user and calendar events of the user, the switching module 300 may switch the electronic device 20a to the meeting mode according to the meeting information or the calendar information.

In at least one embodiment, the identifying module 400 may further obtain a meeting time according to the meeting information or the calendar information, the switching module 300 may switch the electronic device 20a to the meeting mode in the meeting time.

In at least one embodiment, the electronic device 20a may further include a Wi-Fi network unit 22 for connecting to networks. The Wi-Fi identification information of the electronic device 20a that may include connection status, signal strength, a Wi-Fi access point (AP) name that the electronic device 20a is connected to and so on. The Wi-Fi identification information, such as the AP name that the electronic device 20a is connected to, may indicate the location of the user is at home or in the company. In at least one embodiment, the status information of the electronic device may include Wi-Fi identification information of the electronic device 20a.

In at least one embodiment, other electronic devices may be connected to the electronic device 20a through the hotspot unit 26 by operations of the user. For example, the electronic device 20a may inform other electronic devices of Wi-Fi identification number and password, other electronic devices may be connected to the electronic device 20a through the hotspot unit 26 according to the Wi-Fi identification number and password.

In at least one embodiment, the identifying module 400 may further determine a location of the user according to Wi-Fi identification information and switch on the meeting mode according to the location of the user. For instance, when the Wi-Fi identification information shows the location of the user is in the company, the identifying module 400 may switch on the meeting mode and synchronously switch on the smart light mode. When the Wi-Fi identification information shows the location of the user is at home, the identifying module 400 may switch on the meeting mode and synchronously switch on the projection mode.

In at least one embodiment, the identifying module 400 may further determine the identity of the user based on Wi-Fi identification information. When other electronic devices are connected to the electronic device 20a, the identifying module 400 may determine the identity of the user according to the Wi-Fi identification number and password which the electronic devices use to connect to the electronic device 20a.

In at least one embodiment, the electronic device 20a may further include a positioning unit 23 for executing positioning function. For instance, the positioning unit 23 may include a Global Positioning System (GPS) and obtain GPS positioning information of the electronic device 20a. In at least one embodiment, the status information of the electronic device 20a may include positioning information of the electronic device 20a.

In at least one embodiment, the identifying module 400 may determine whether to switch on the meeting mode and corresponding functions according to the calendar information and the GPS positioning information. For instance, when the GPS positioning information shows the location of the user is in the company, the identifying module 400 may switch on the meeting mode and synchronously switch on the smart light mode. When the GPS positioning information shows the location of the user is at home, the identifying module 400 may switch on the meeting mode and synchronously switch on the projection mode.

In at least one embodiment, when the identifying module 400 may further determine whether there is an attachment in the calendar information during the meeting mode, the identifying module 400 may automatically switch on the projection mode for projecting the attachment.

In at least one embodiment, the identifying module 400 may detect a brightness of the environment where the electronic device 20a locates in. The electronic device 20a may obtain the light brightness information by detecting a brightness of the environment where the electronic device 20a locates in. When the brightness of the environment where the electronic device 20a locates in is less than a predetermined brightness, the identifying module 400 may switch on the smart light mode.

An example of the electronic device 20a being switched to the meeting mode will be described in the following.

When the user speaks, such as “switch on the meeting mode”, the receiving module 100 receives audio information, the audio unit 21 collects the audio information from the user and forwards to the receiving module 100. The receiving module 100 transmits the audio information to the identifying module 400.

The identifying module 400 analyzes the audio information and obtains the keyword “meeting mode”. The obtaining module 200 obtains GPS positioning information through the positioning unit 23 and obtains Wi-Fi identification information through the Wi-Fi network unit 22, to determine the identity of the user. Specifically, if the user's electronic devices are connected to the electronic device 20a through the hotspot unit 26, when the user's electronic devices are connected to the electronic device 20a, the hotspot unit 26 may assign Wi-Fi identification number and password to user's electronic devices, user's electronic devices may be connected to the electronic device 20a through the Wi-Fi network unit 22. Thus, the identifying module 400 may determine the identity of the user according to the Wi-Fi identification number and password.

The switching module 300 switches the electronic device 20a to the meeting mode based on the input information and identity information of the user, invokes the calendar of the user according to the identity of the user, and obtains calendar information in the calendar of the user. The calendar information may include meeting time, meeting software, meeting ID, and meeting password, etc. The switching module 300 transmits the calendar information to the control unit 27 after the electronic device 20a is switched to the meeting mode.

For instance, the calendar information in the calendar may be “dear Mr./Mrs. XX, please join the online meeting XXX at 10:30 on May 20, 20XX, the meeting number is XXXXXXXX, the meeting password is XXXXXX, you can join the meeting by the meeting link WWW.XXXX.XXX.”

The control unit 27 controls the electronic device 20a to launch corresponding meeting software in the scheduled meeting time and automatically join the meeting by the meeting link, the meeting ID, and the meeting password.

The system 10 for switching multi-function modes may identify the identity of the user according to the input information from the user, switches the electronic device 20a to corresponding modes according to the identity of the user, which may reduce repetitive manual operations of the user.

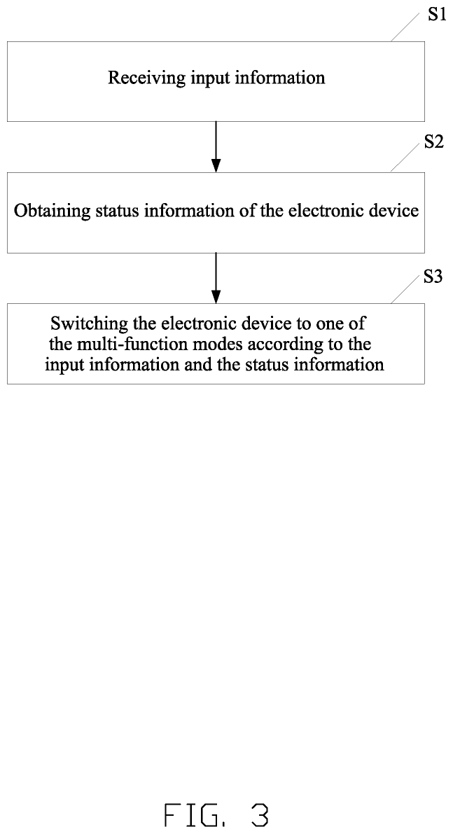

FIG. 3 illustrates a flowchart of at least one embodiment of a method for switching multi-function modes.

In at least one embodiment, the method for switching multi-function modes may be applied in a system, such as the system 10 for switching multi-function modes shown in FIGS. 1 and 2. The functions may be integrated in the system 10 for the method for switching multi-function modes. In another embodiment, the method for switching multi-function modes can be run in a form of software development kit in the system 10.

The method is provided by way of example, as there are a variety of ways to carry out the method. Each block shown in FIG. 3 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block S1.

At block S1, receiving input information.

Receiving the input information though the receiving module 100, a specific way of receiving the input information may be referred to the description in FIGS. 1 and 2.

At block S2, obtaining status information of the electronic device.

Obtaining the status information of the electronic device through the obtaining module 200, a specific way of obtaining the status information may be referred to the description in FIGS. 1 and 2.

At block S3, switching the electronic device to one of the multi-function modes according to the input information and the status information.

Switching the electronic device 20, 20a to one of the multi-function modes according to the input information and the status information through the switching module 300, a specific way of switching the electronic device may be referred to the description in FIGS. 1 and 2.

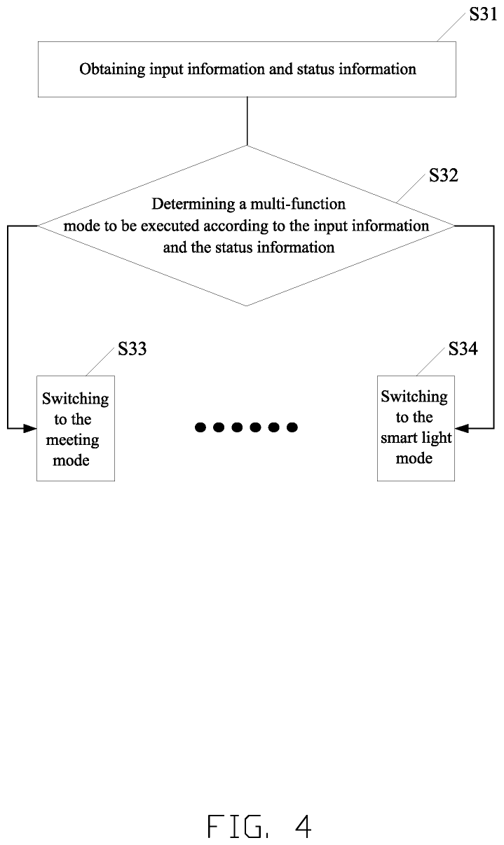

FIG. 4 illustrates a flowchart of at least one embodiment of the method for switching multi-function modes. In at least one embodiment, the method for switching multi-function modes may be applied in a system, such as the system 10 for switching multi-function modes shown in FIGS. 1 and 2. The example method can begin at block S31.

At block S31, obtaining input information and status information.

Obtaining the input information though the receiving module 100 and the status information though the obtaining module 200, a specific way of obtaining the input information and the status information may be referred to the description in FIGS. 1 and 2.

At block S32, determining a multi-function mode to be executed according to the input information and the status information.

Determining the multi-function mode to be executed according to the input information and the status information through the switching module 300, a specific way of determining the multi-function mode may be referred to the description in FIGS. 1 and 2.

At block S33, switching to the meeting mode.

At block S34, switching to the smart light mode.

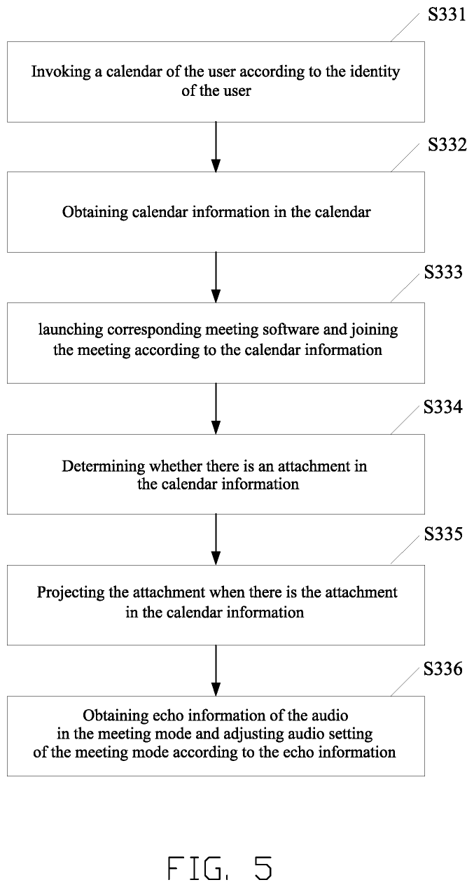

FIG. 5 illustrates a flowchart of one embodiment of the method for switching multi-function modes to a meeting mode.

At block S331, invoking a calendar of the user according to the identity of the user.

At block S332, obtaining calendar information in the calendar.

In at least one embodiment, the calendar meeting information may include meeting time, meeting software, meeting ID, and meeting password, etc.

At block S333, launching corresponding meeting software and joining the meeting according to the calendar information.

In at least one embodiment, launching corresponding meeting software in the scheduled meeting time and joining the meeting by the meeting link, the meeting ID, and the meeting password.

At block S334, determining whether there is an attachment in the calendar information.

At block S335, projecting the attachment when there is the attachment in the calendar information.

At block S336, obtaining echo information of the audio in the meeting mode and adjusting audio setting of the meeting mode according to the echo information.

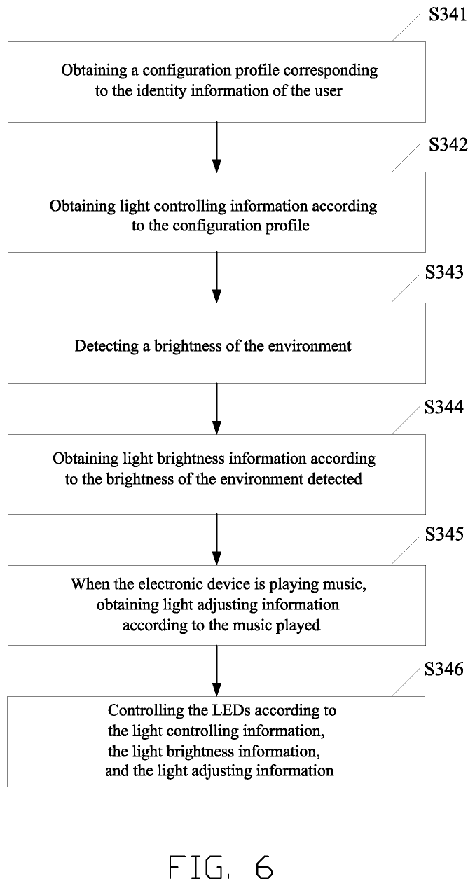

FIG. 6 illustrates a flowchart of one embodiment of the method for switching multi-function modes to a smart light mode.

At block S341, obtaining a configuration profile corresponding to the identity information of the user.

At block S342, obtaining light controlling information according to the configuration profile.

At block S343, detecting a brightness of the environment.

At block S344, obtaining light brightness information according to the brightness of the environment detected.

At block S345, when the electronic device is playing music, obtaining light adjusting information according to the music played.

At block S346, controlling the LEDs according to the light controlling information, the light brightness information, and the light adjusting information.

In at least one embodiment, controlling the LEDs including, controlling a frequency of strobing of the LEDs, the color of the LEDs and the brightness of the LEDs.

In the blocks S33-S34, switching the electronic device 20a to corresponding multi-function modes to be executed, such as the meeting mode, the projection mode, and the smart light mode, through the switching module 300, a specific way of switching the multi-function mode may be referred to the description in FIGS. 1 and 2.

It should be known that, the multi-function modes shown in the blocks S33-S34 are just an example in the at least one embodiment, but are not limited to these.

A non-transitory computer-readable storage medium including program instructions for causing the apparatus to perform the method for multi-function mode switching is also disclosed.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A method for switching multi-function modes applied in an electronic device, the electronic device having a plurality of hardware module functions, the method comprising:
receiving input information from a user of the electronic device;
obtaining status information of the electronic device; and
switching the electronic device to one of the multi-function modes according to the input information and the status information;
wherein, each of the multi-function modes corresponds to at least one of the plurality of hardware module functions.

2. The method according to claim 1, further comprising:
identifying identity information of the user according to the input information and the status information;
switching the electronic device to one of the multi-function modes according to the input information and the status information comprises:
switching the electronic device to one of the multi-function modes according to at least one of the input information, the identity information of the user, and the status information of the electronic device.

3. The method according to claim 1, wherein the status information of the electronic device comprises positioning information or Wi-Fi identification information of the electronic device.

4. The method according to claim 2, further comprising:
obtaining calendar information corresponding to the identity information of the user.

5. The method according to claim 4, further comprising:
when the input information from the user comprising meeting information, switching the electronic device to a meeting mode.

6. The method according to claim 4, further comprising:
automatically connecting the electronic device to a meeting according to the identity information of the user and the meeting information.

7. The method according to claim 3, further comprising:
when the input information from the user comprising light information, switching the electronic device to a smart light mode.

8. The method according to claim 2, wherein the input information of the user is voice command information.

9. The method according to claim 1, wherein the multi-function modes comprise at least one of a meeting mode, a smart light mode, a wireless charging mode, a projection mode, and a hotspot mode.

10. A system for switching multi-function modes applied in an electronic device, the electronic device having a plurality of hardware module functions, the system comprising:
a receiving module, the receiving module configured to receive input information from a user of the electronic device;
an obtaining module, the obtaining module configured to obtain status information of the electronic device; and
a switching module, the switching module configured to switch the electronic device to one of the multi-function modes according to the input information and the status information;
wherein each of the multi-function modes corresponds to at least one of the plurality of hardware module functions.

11. The system according to claim 10, further comprising an identifying module, wherein the identifying module is configured to identify identity information of the user according to the input information and the status information;
the switching module is further configured to switch the electronic device to one of the multi-function modes according to at least one of the input information, the identity information of the user, and the status information of the electronic device.

12. The system according to claim 10, wherein the status information of the electronic device comprises positioning information or Wi-Fi identification information of the electronic device.

13. The system according to claim 11, wherein the obtaining module is further configured to obtain calendar information corresponding to the identity information of the user.

14. The system according to claim 13, wherein the switching module is further configured to switch the electronic device to a meeting mode when the input information from the user comprises meeting information.

15. The system according to claim 13, wherein the switching module is further configured to automatically connect the electronic device to a meeting according to the identity information of the user and the meeting information.

16. The system according to claim 12, wherein the switching module is further configured to switch the electronic device to a smart light mode when the input information from the user comprising light information.

17. The system according to claim 11, wherein the input information of the user is voice command information.

18. The system according to claim 10, wherein the multi-function modes comprise at least one of a meeting mode, a smart light mode, a wireless charging mode, a projection mode, and a hotspot mode.

19. A system for switching multi-function modes applied in an electronic device, the electronic device having a plurality of hardware module functions, the system comprising:
a processor; and
a memory coupled to the processor and storing program instructions; the memory and the program instructions configured to, with the processor, cause the system to perform:
receiving input information from a user of the electronic device;
obtaining status information of the electronic device; and
switching the electronic device to one of the multi-function modes according to the input information and the status information;
wherein each of the multi-function modes corresponds to at least one of the plurality of hardware module functions.

20. The system according to claim 19, wherein the memory and the program instructions configured to, with the processor, cause the system to further perform:
identifying identity information of the user according to the input information and the status information;
switching the electronic device to one of the multi-function modes according to the input information and the status information comprises:
switching the electronic device to one of the multi-function modes according to at least one of the input information, the identity information of the user, and the status information of the electronic device.
